(19) United States
(12) Patent Application Publication
(10) Pub. No.: US 2014/0092060 A1
(43) Pub. Date: Apr. 3, 2014

(54) TOUCH PANEL

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: KUAN-HONG HSIEH, New Taipei (TW); RUEY-SHYANG YOU, New Taipei (TW); BIN-GANG DUAN, Shenzhen (CN); ZONG-HUI DONG, Shenzhen (CN); ZI-FANG CAI, Shenzhen (CN); FAN-LIN LU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/037,382

(22) Filed: Sep. 26, 2013

(30) Foreign Application Priority Data
Sep. 29, 2012 (CN) 201210371424X

(51) Int. Cl. G06F 3/02; G06F 3/045; G06F 3/044

(52) U.S. Cl. CPC G06F 3/0202; G06F 3/044; G06F 3/045
USPC 345/174

(57) ABSTRACT

A touch panel includes a cover layer including a number of key areas, a circuit board, a touch-sensing layer arranged between the cover layer and the circuit board, and a number of button members corresponding to the key areas one by one. Each button member includes a post and a sensing portion. The touch-sensing layer generates a first signal to indicate a location of a user's touch when the touch panel is in a touch mode. The sensing portion generates a second signal when a corresponding key area is pressed when the touch panel is in a button mode.

### BACKGROUND

1. Technical Field

The present disclosure relates to input devices, and particularly to a touch panel with a button-input mode.

2. Description of Related Art

Many electronic devices have input devices. Two usual input methods are buttons and touch panels. The buttons have the benefit of providing tactile feedback when pressed, such as clicking or resisting being pressed when the button has been pressed far enough. However, the appearance of buttons on an electronic device is not as aesthetic as touch panels. On the other hand, a touch panel is more aesthetic, but does not provide the tactile feedback of buttons and may feel unsatisfactory to a user.

Therefore, what is needed is a touch panel having an aesthetic appearance and providing a button-input mode.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, cross-sectional view showing a touch panel, according to an exemplary embodiment.

FIG. 2 is a schematic, isometric view of the touch panel of FIG. 1.

FIG. 3 is a schematic, cross-sectional view of an insulating layer and a touch-sensing layer of the touch panel of FIG. 1.

### DETAILED DESCRIPTION

The disclosure, including the accompanying, is illustrated by way of example and not by way of limitation. It should be noted that references to “an” or “one” embodiment in this disclosure are not necessarily to the same embodiment, and such references mean “at least one.”

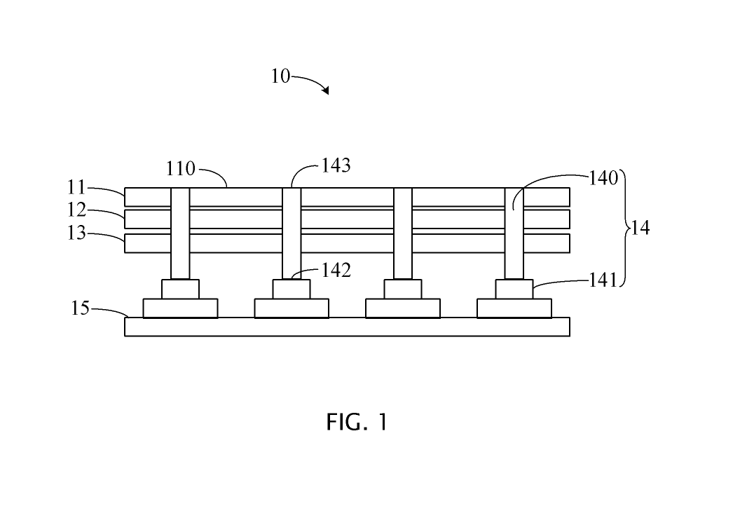

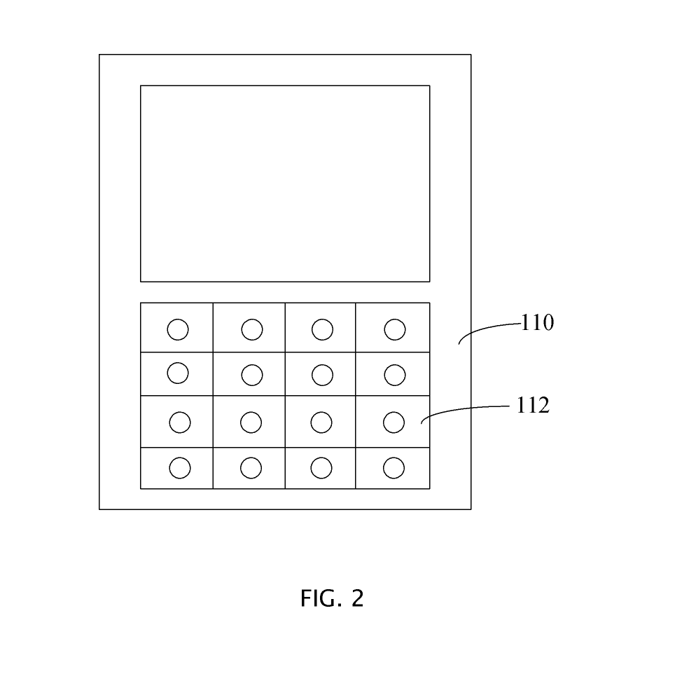

Referring to FIG. 1 and FIG. 2, a touch panel 10 according to an exemplary embodiment is illustrated. The touch panel 10 includes a cover layer 11, an insulating layer 12, a touch-sensing layer13, a number of button members 14, and a circuit board 15. An operative surface 110 of the cover layer 11 is divided into a number of key areas 112. In one embodiment, the cover layer 11 is made of transparent plastic material, such as polyester. The touch panel is operable between a touch mode and a button mode.

The insulating layer 12 is attached to another surface of the cover layer 11 opposite to the operating surface 110. The touch-sensing layer13 is arranged between the insulating layer 12 and the circuit board 15 and is electrically connected to the circuit board 15. The touch-sensing layer 13 is configured to generate a first signal to indicate a location of a user's touch. In a touch mode, when a conductor, such as a human finger or a touch pen, touches the cover layer 11, an electrical signal at a point of contact of the touching sensing layer 13 indicates the location of the touch. The touching sensing layer 13 can be a resistive touching layer or a capacitive touching layer. In other embodiments, the touch-sensing layer13 is attached on the cover layer 11.

Each of the button members 14 includes a post 140 and a sensing portion 141. Each of the sensing portions 141 is electrically connected to the circuit board 15. Each of the button members 14 is respectively aligned with the key area 112 of the operating surface 110.

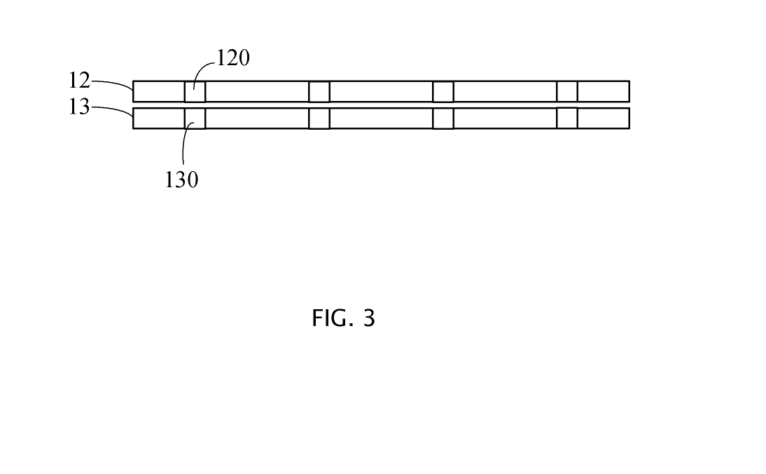

Referring to FIG. 3, the insulating layer 12 includes a number of through holes 120 corresponding to the posts 140 of the button members 14, and the touch-sensing layer 13 also includes a number of through holes 130 corresponding to the posts 140. The through holes 120 of the insulating layer 12 and the through holes 130 of the touch-sensing layer 13 are aligned with each other. A first end 143 of the post 140 is received by a corresponding through hole 120 and a corresponding through hole 130, and connects to the cover layer 11. In this embodiment, a second end 142 of the post 140 resists a corresponding sensing portion 141. In other embodiments, a space is formed between the second end 142 and the sensing portion 141.

The sensing portion 141 is configured to generate a second signal when the corresponding key area 112 is pressed. In a button mode, when a key area 112 of the operating surface 110 is pressed by a user, the second end 142 of the post 140 presses the sensing portion 141, and the sensing portion 141 deforms and generates the second signal. The pressed point is then determined based on the second signal.

In an embodiment, the sensing portion 141 includes a metal dome and contacting tabs. When the sensing portion 141 is pressed by the second end 142 of the post 140, the metal dome deforms and contacts the contacting tab, thereby generating the second signal.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A touch panel being operable between a touch mode and a button mode, comprising:
a cover layer comprising an operative surface, wherein the operative surface comprises a number of key areas;
a circuit board;
a touch-sensing layer arranged between the cover layer and the circuit board, the touch-sensing layer configured to generate a first signal to indicate a location of a touch in response user's touching in the touch mode, the touch-sensing layer comprising a plurality of holes respectively aligned with the corresponding key areas; and
a plurality of button members respectively aligned with the corresponding key areas, each button member comprising a post and a sensing portion electrically connected to the circuit board;
wherein each of the post includes a first end and a second end, the first end passes through the corresponding hole and connects to the cover layer, the second end of the post is resisted on the sensing portion when the corresponding key area is pressed, the sensing portion deforms and generates a second signal in the button mode.

2. The touch panel as described in claim 1, wherein the cover layer is made of transparent plastic.

3. The touch panel as described in claim 2, wherein the cover layer is made of polyester.

4. The touch panel as described in claim 1, further comprising an insulating layer arranged between the cover layer and the touch-sensing layer.

5. The touch panel as described in claim 1, wherein the insulating layer comprises a plurality of holes respectively aligned with the holes of the touch-sensing layer.

6. The touch panel as described in claim 1, wherein the touching sensing layer is a resistive touching layer or a capacitive touching layer.
